(19) United States
(12) Patent Application Publication
(10) Pub. No.: US 2009/0213824 A1
(43) Pub. Date: Aug. 27, 2009

(54) Wireless local area network packet transmitting and receiving system

(75) Inventor: Chih-Chang Chen, Hsinchu (TW)

Correspondence Address: EDWARDS ANGELL PALMER & DODGE LLP, P.O. BOX 55874, BOSTON, MA, 02205, US

(73) Assignee: Ralink Technology Corporation, Hsinchu (TW)

(21) Appl. No.: 12/315,594

(22) Filed: Dec. 4, 2008

(30) Foreign Application Priority Data
Feb. 22, 2008 (TW) 097106200

(51) Int. Cl. H04W 84/12

(52) U.S. Cl. 370/338

(57) ABSTRACT

A wireless local area network transmitting and receiving system includes a network driver interface, a random network layer, an infrastructure layer, a packet format conversion module and a distributed module. The packet format conversion module provides the wireless local area network with bridges to receive and convert wireless local area packets of the infrastructure layer, and then executes processes of transmitting and receiving the wireless local area network packets instructed by the network driver interface. The distribution module is connected to the infrastructure layer and the random network layer and then transmits the wireless local area network packets.

### BACKGROUND OF THE INVENTION

1. Field of the Invention

This invention generally relates to wireless local area network packet transmitting and receiving systems, and more specifically, to a network driver interface for providing bridges to a wireless local area network for receiving and converting wireless local area network packets of the infrastructure layer, and then enabling a packet format conversion module to execute the processes of transmitting and receiving wireless local area network packets instructed by the network driver interface.

2. Description of Related Art

Conventional wireless local area network is a network framework for transmitting data without need of wired network lines. In a regular usage environment, an Access Point (AP) base station is installed to connect and exchange data with one or more users' computers that are installed with wireless local area network cards (wireless LAN cards), thereby providing wireless convenience.

Generally, the AP base station might comprise routing function, which is similar to a conventional IP sharing device. When more than one computer in a house needs to use the Internet at the same time, the most convenient approach is to purchase a single AP base station and a number of wireless network cards.

For example, Taiwan Patent Publication No. 200723755 has disclosed a wireless local area network signal detection method. Please refer to FIG. 1, which is a diagram illustrating the connection between a wireless local area network and a base station platform. When a conventional wireless network signal detection device 1′ transmits or receives a wireless local area network packet, a workstation 6 of user terminal first sends out a packet, and a wireless local area network packet receiving software 31 of an Access Point base station 3 (wireless Access Point or a wireless local area network device) executes the command of transmitting the packet to the wireless network signal detection device 1′ for further process. The wireless network signal detection device 1′ is applicable to data process devices, such as a computer and other devices that have wireless network connection function.

According to the prior art, the wireless network signal detection device 1′ comprises a packet transmission module 11′, a packet detection module 12′, a prompt module 13′, a storage module 15′ and a power supply module 14′, wherein the packet transmission module 11′ receives an external wireless local area network packet no matter whether the wireless network signal detection device 1′ connects to the wireless local area network device 3 or not. After the wireless network signal detection device 1′ connects to the wireless local area network device 3, the packet transmission module 11′ receives data sent from the wireless local area network device 3 and converts the data to a wireless local area network packet that is to be transmitted externally. The packet detection module 12′ produces a signal intensity packet after detecting the signal intensity of the wireless local area network packet received by the packet transmission module 11′. The wireless network signal detection device 1′ instructs the prompt module 13′ to produce prompt packet according to the signal intensity packet. The storage module 15′ stores every basic service set identifier (BSSID) set inside the wireless network signal detection device 1′, and the power supply module 14′ provides power for all the components of the wireless network signal detection device 1′.

In the aforesaid prior art, an Access Point base station is used for transmitting data, a user's mobility in terms of getting online is enhanced for short distance local area network. However, an Access Point base station has to be purchased and then allocated externally to user's computer, thereby increasing the user's cost. In addition, in practical applications, if wireless local area network packet receiving software (Soft-AP) is built inside a computer, the wireless local area network packet receiving software has the advantages such as mobility and convenience of wireless communication far above a wired network as well as the wireless local area network (WLAN) that needs additional Access Point base station, so that no additional Access Point base station is needed, and there is more flexibility in usage. Most of all, the conventional Access Point base station cannot solve the problem of incompatibility with the Windows Vista operating system.

The existing Access Point base station is a hardware of Access Point base station disposed with a wireless local area network packet receiving software, and personal computers and notebook computers connect to the wireless station of the Access Point base station. Current Windows Vista operating system has only WI-FI layer to process IEEE 802.11. However, WI-FI layer only supports packets transmitted by infrastructure layer and random network layer (ad-hoc mode). In other words, the network driver framework (i.e. NDIS framework) of the current Widows Vista operating system supports the infrastructure layer and the random network layer only. However, Access Point base station does not have infrastructure layer and random network layer that are similar to random network mode. Therefore, the wireless local area network packet receiving mechanism of an Access Point base station cannot connect with the Windows Vista operating system.

Hence, there is an urgent need to provide a system that is compatible with the Windows Vista operating system and can effectively solve the drawbacks mentioned above. Consequently, neither externally allocating a wireless base station nor changing or affecting the existing network model framework of computer operating system is required in the present invention. The restrictions of the current operating system network model are thus further eliminated in the present invention.

### SUMMARY OF THE INVENTION

In view of the disadvantages of the prior art mentioned above, the present invention provides a wireless local area network packet transmitting and receiving system for eliminating the restrictions of Wi-Fi layer in the Windows Vista operating system by building two model layers and a wireless local area network packet receiving mechanism inside a network driver interface.

Further, the present invention provides a wireless local area network packet transmitting and receiving system for connecting an Access Point base station and the Windows Vista operating system in the current network model framework of the Windows Vista operating system.

In addition, the present invention provides a wireless local area network packet transmitting and receiving system for saving space and cost of purchasing an Access Point base station.

In accordance with the present invention, the wireless local area network transmitting and receiving system has the functions of an Access Point base station built inside a personal computer or a notebook computer. The wireless local area network transmitting and receiving system of the present invention comprises: a network driver interface, which receives commands of activating actionsand and is connected with a communication protocol; a random network layer built inside the network driver interface to receive and send wireless packets within the transmission power of the network driver interface; an infrastructure layer built inside the network driver interface to integrate wired and wireless local area network packets from the random network layer; a packet format conversion module disposed between the random network layer and the infrastructure to provide bridges of wireless local area network, receive and convert wireless local area network packets of the infrastructure layer, and execute processes of transmitting and receiving wireless local area network packets instructed by the network driver interface; and a distribution module disposed between the random network layer and the infrastructure layer to connect the infrastructure layer and the random network layer to transmit wireless packets.

The wireless local area packet transmitting and receiving system of the present invention adopts the functions similar to an Access Point base station for transmitting information, and is capable of increasing the spacial scope for wireless local area network signal waves of user's computer as well as enhancing the practicability and convenience of wireless online access. The wireless local area network packet transmitting and receiving system of the present invention has two additional model layers and a wireless local area network packet receiving mechanism to the network driver interface for providing wireless online access in the existing supportive network model framework of the Windows Vista operating system without being restricted by the network lines. In addition, when applying the wireless local area network packet transmitting and receiving system of the present invention, there is no need to purchase an additional Access Point base station, thereby saving space and cost. Furthermore, since the wireless local area network packet transmitting and receiving system of the present invention has two additional built-in model layers and a built-in wireless local area network packet receiving mechanism, these internal allocations can replace the conventional Access Point base station.

### BRIEF DESCRIPTION OF DRAWINGS

The present invention can be more fully understood by reading the following detailed description of the preferred embodiments, with reference made to the accompanying drawings, wherein:

FIG. 1 is a diagram illustrating the connection between a wireless local area network and an Access Point base station according to Taiwan Patent Publication No. 200723755;

FIG. 2 is a diagram illustrating main modules of a wireless local area network packet transmitting and receiving system according to the present invention;

FIG. 3 is a diagram illustrating the sending and receiving wireless local area network packets according to an embodiment of the present invention;

FIG. 4 is a diagram of a practical packet structure in standard panel format of IEEE 802.11 wireless local area network specification;

FIG. 5 is a diagram illustrating a practical packet transmission in standard panel format of IEEE 802.11 wireless local area network specification;

FIG. 6 is a packet transmission flowchart of the wireless local area packet transmitting and receiving system of the present invention; and

FIG. 7 is a packet receiving flowchart of the wireless local area packet transmitting and receiving system of the present invention.

### DETAILED DESCRIPTION OF PREFERRED EMBODIMENTS

The following illustrative embodiments are provided to illustrate the present invention. These and other advantages and effects can be apparently understood by those skilled in the art after reading the specification. The present invention can also be performed or applied by other different embodiments. The details of the specification may be on changed the basis of different points and applications, and numerous modifications and variations can be derived without departing from the spirit of the present invention.

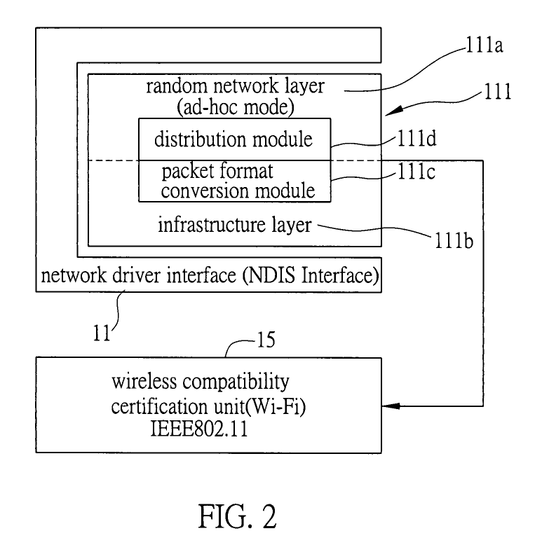

Please refer to FIGS. 2 through 4, which are diagrams of an embodiment of the wireless local area network packet transmitting and receiving system of the present invention. In the following descriptions of embodiments, the network driver interface is connected to a computer as an example, wherein the computer can be, but not limited to, a personal computer, a notebook computer, or a personal digital assistant (PDA). In addition, in the present embodiment, the network driver interface is connected to a computer installed with the Windows Vista operating system platform; however, the network driver interface can be connected to computers with other operating system platforms.

As shown in FIG. 2, the present embodiment is applied to a network driver interface 11, and the network driver interface 11 is applied to a computer 1. The wireless local area network packet transmitting and receiving system of the present invention includes a network driver interface 11 allocated in the computer 1; a random network layer 111a and an infrastructure layer 111b allocated to the network driver interface 11; and a packet format conversion module 111c having wireless local area network bridges and the function of wireless local area network packet receiving software; and a distribution module 111d for connecting the infrastructure layer 111b and the random network layer 111a and for transmitting wireless packets.

More specifically, the network driver interface 11 is activated by the computer 1 to initiate the processes of transmitting/receiving wireless packets to/from various sources, commanding the random network layer 111a to receive/send wireless packets sending from/to each workstation 6 within transmission power of the network driver interface, integrating wired and wireless local area network packets received by the random network layer 111a, and transmitting the network packets to the infrastructure layer 111b.

The wireless local area network packet transmitting and receiving system of the present invention further includes a packet format conversion module 111c disposed between the random network layer 111a and the infrastructure layer 111b. The packet format conversion module 111c has wireless local area bridge function and wireless local area network packet receiving function. A distribution module 111d is disposed between the random network layer 111a and the infrastructure layer 111b and is connected to the infrastructure layer 111b and the random network layer 111a to transmit wireless packets. After being connected with the distribution module 111d, workstations exchange wireless packets with one another via the distribution module 111d, thereby expanding the area of transmitting and receiving wireless packets. Furthermore, the network driver interface 11 provides the wireless packets received by the packet format conversion module 111c to a wireless compatibility certification unit 15. The wireless compatibility certification unit 15 compares and certifies whether the wireless packets come from a compatible network. The wireless compatibility certification unit 15 can follow the IEEE 802.11 standard, or the Wi-Fi standard.

In the present embodiment, based on technical concepts similar to those applied in the present invention, those of ordinary skills in the art can modify the packet format conversion module 111c, the distribution module 111d, the infrastructure layer 111b and the random network layer 111a to other correspondingly equivalent framework. In other words, the packet format conversion module 111c and the distribution module 111d are not limited to be built inside the infrastructure layer 111b, inside the random network layer 111a, or between the infrastructure layer 111b and the random network layer 111a. Therefore, any structure for receiving and converting wireless local area network packets of infrastructure layer 111b, executing the processes of sending and receiving wireless packets instructed by the network driver interface 11, connecting the infrastructure layer 111b and the random network layer 111a, and transmitting wireless packets falls in the scope of the present invention. Since the abovementioned modifications are well understood by those in the art, no further description is given herein.

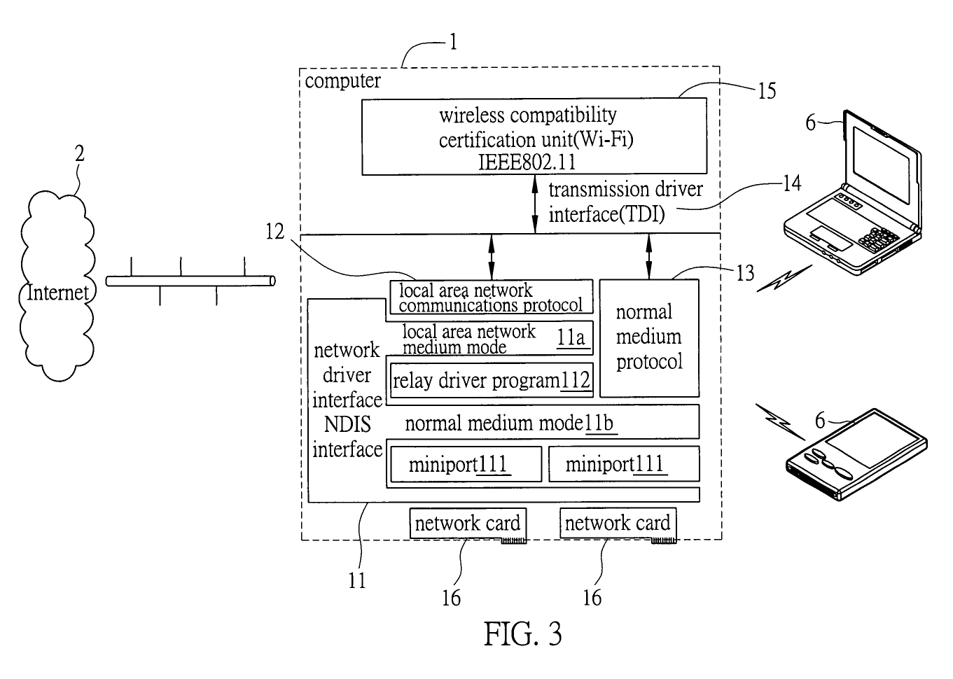

Please refer to FIG. 3, which is a diagram showing an embodiment of the wireless local area network packet transmitting and receiving system according to the present invention. To simply the description of the present embodiment, detailed descriptions of components that are similar to those in the previous embodiment are not repeated. As shown in FIG. 3, the wireless local area network packet transmitting and receiving system includes a network driver interface 11 allocated to the computer 1, wherein a local area network medium mode 11a, a normal medium mode 11b, at least one miniport 111, a relay driver program 112, a local area network communications protocol 12, a normal medium protocol 13, a transmission driver interface 14, a wireless compatibility certification unit 15, a network card 16, etc. are all allocated within or to the network driver interface 11.

In the present embodiment, the miniport 111 is built inside the network driver interface 11, and is a miniature framework of the main system modules of the previous embodiment of the present invention as shown in FIG. 2. The steps of transmitting and receiving wireless local area network packets in the present embodiment are entirely similar to the steps in the previous embodiment, and thus the associated descriptions are hereby omitted.

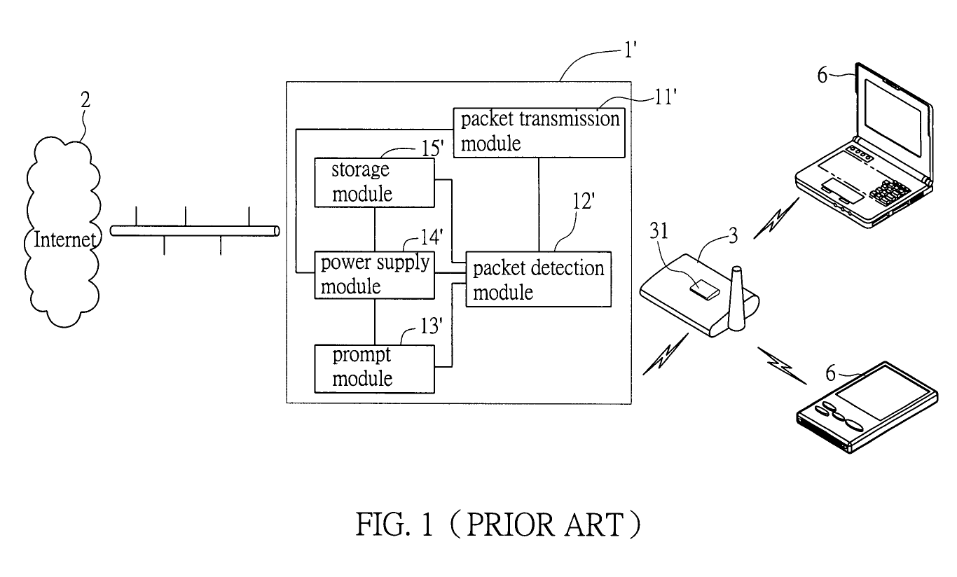

As shown in FIG. 1, when a general workstation 6 is transmitting and receiving a wireless local area network (WLAN) packet, the WLAN packet must be sent from workstation 6, and then wireless local area network packet receiving software 31 of the Access Point base station 3 executes a command for transmitting the WLAN packets to the wireless network signal detection device 1′. However, according to the present invention, as shown in FIG. 3, the WLAN packets can be directly transmitted to the built-in miniport 111 of the network driver interface 11 of the computer 1 of the present invention.

According to aforesaid embodiments, the present invention allows a user to go online without the problem caused by using wired network lines while not affecting the existing random network model framework of the Windows Vista operating system of computer 1. Since the Windows Vista operating system can only process and support the infrastructure layer 111b and the random network layer 111a, allocating two additional built-in model layers and a wireless local area network packet receiving software to the network driver interface 11 directly provides a solution to eliminate restrictions for the workstations 6. In order to connect an Access Point base station and the Windows Vista operating system without influencing the existing network model framework of the Windows Vista operating system, a network driver interface is allocated with two additional built-in model layers and a wireless local area network packet receiving software. On the contrary, in the prior art, the computer is externally allocated with an Access Point base station with wireless local area network packet receiving software within. In the present invention, there is no need to purchase an Access Point base station, thereby saving space and cost, and also overcoming the incompatibility problem between an existing Access Point base station and the Windows Vista operating system. In addition, in the design of the computer network driver interface 11 of the invention, since the allocation of two additional built-in model layers and a wireless local area network packet receiving software is functionally equivalent to the prior Access Point base station, wired network lines and an Access Point base station are eliminated, thereby overcoming conventional drawbacks. The wireless local area network packet transmitting and receiving system of the present invention provides higher design flexibility, and overcomes disadvantages and inconvenience of the prior art.

In addition, in another embodiment of the present invention, the network driver interface applied to the wireless local area network packet transmitting and receiving system further includes a switch module, and also the network driver interface has a general workstation mode. The switch module enables the network driver interface to switch either to a station mode or to a software Access Point base station (Soft-AP) mode provided by the wireless local area network packet transmitting and receiving system of the present invention. Specifically, when switching to the workstation mode, the network driver interface has the same function as the prior network driver interface, and therefore an Access Point base station is required for the process of transmitting and receiving wireless local area network packet to/from other wireless network transmitting and receiving device. When switching to the software Access Point base station function, the network driver program is activated to run the wireless local area network packet transmitting and receiving system of the present invention, thereby performing the software Access Point base station function.

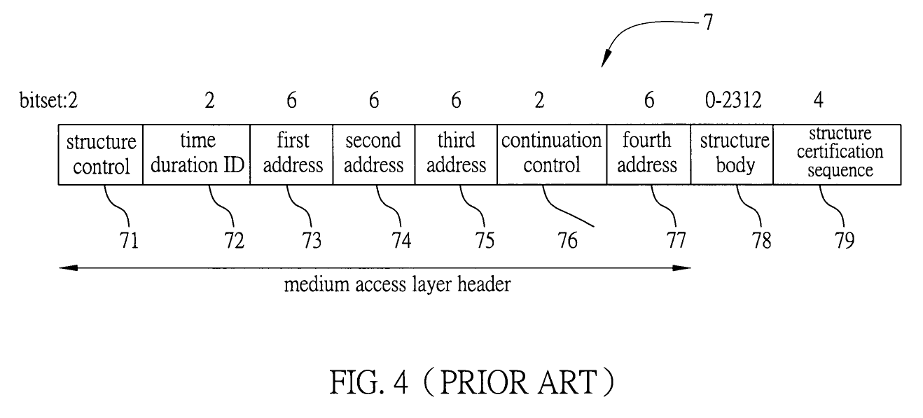

The following is detailed description of the packet transmitting process of the wireless local area network packet transmitting and receiving system of the present invention. Please refer to FIG. 4, which is a diagram showing the packet structure of the existing mainstream standard panel format of the IEEE 802.11 wireless local area network specification. The packet structure of the wireless local area network packet transmitting and receiving system in the embodiment of the present invention includes a structure control 71, a time duration ID 72, a first address 73, a second address 74, a third address 75, a continuation control 76, a fourth address 77, a structure body 78, and a structure certification sequence 79. The packet structure operates on the medium receiving layer of the network model, and initiates connection based on the structure control 71 of the packet header of the data connection layer, whereupon, the entire packet structure certification process comes to an end via the structure certification sequence 79.

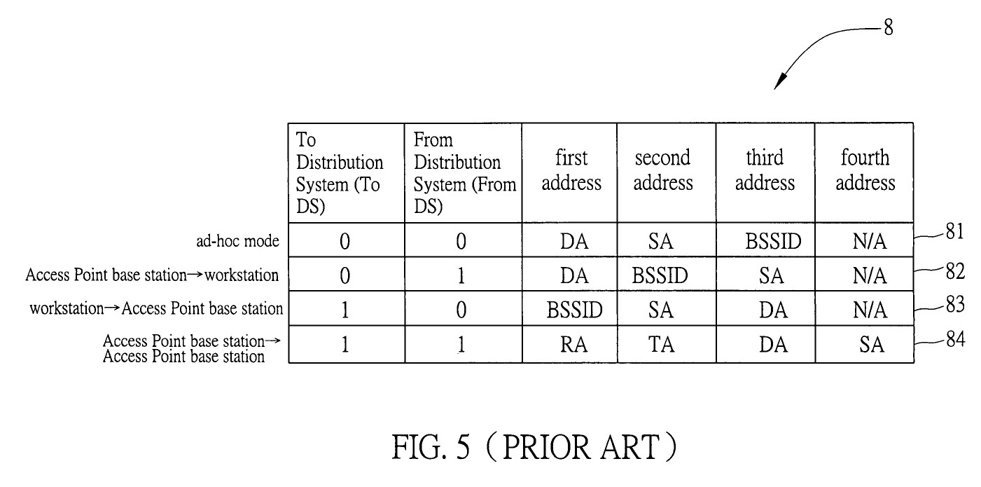

According to FIG. 5, which illustrates the packet transmission mode 8 in standard panel format of the 802.11 wireless local area network specification. The packet transmission modes include an ad-hoc mode 81, an Access Point base station to workstation mode (WAP to STA) 82, a workstation to Access Point base station mode (STA to WAP) 83, and an Access Point base station to Access Point base station mode (WAP to WAP) 84. The structure control 71 consists of two bits for controlling/indicating “to distribution system” (To DS) and “from distribution system” (From DS) respectively, wherein “to distribution system” (To DS) and “from distribution system” (From DS) are indicated by 0 or 1, which directly affects subsequent packet transmission mode directly. In addition, following the distribution system (DS), four transmission columns (address1 through address 4) are provided. The four transmission columns includes a destination address (DA), a source address (SA), a wireless local area network basic service set identifier (BSSID), a front end registration authority (RA), a target address (TA), and so on.

According to the packet structure of the standard panel format of the 802.11 wireless local area network specification and its four basic packet transmission modes, the followings are specific descriptions of the main transmitting and receiving modes of the wireless local area network packet transmitting and receiving system of the present invention:

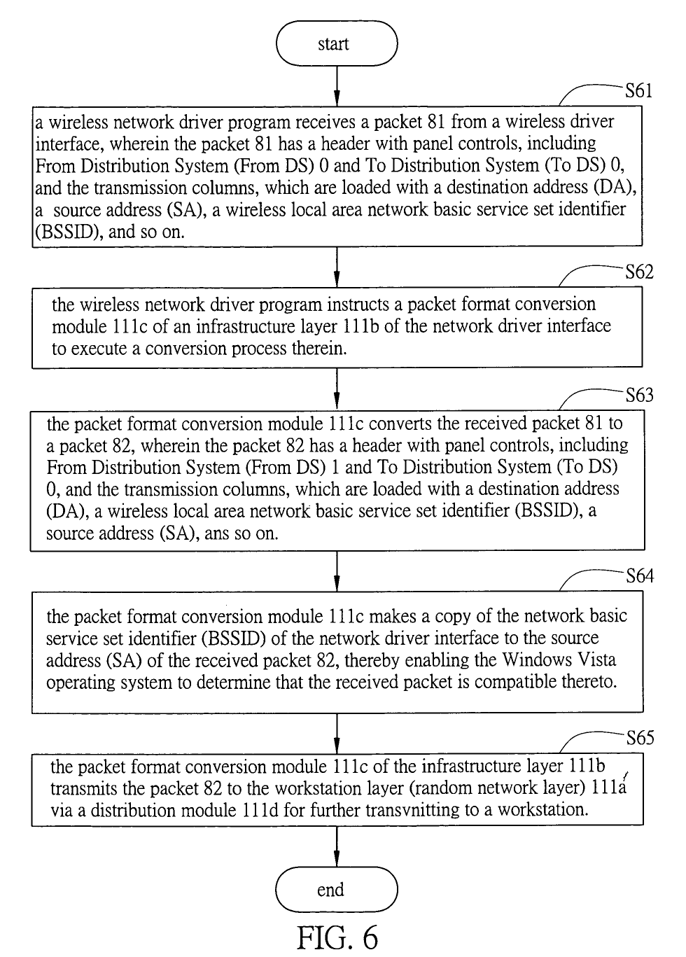

Please refer to FIG. 6, which is a packet transmission flowchart according to the wireless local area network packet transmitting and receiving system of the present invention. As shown in FIG. 6, in step S61, the wireless network driver program receives a packet 81 from the wireless driver interface, wherein the packet 81 has a header with panel controls, including From Distribution System (From DS) 0 and To Distribution System (To DS) 0, and the transmission columns, which are loaded with a destination address (DA), a source address (SA), a wireless local area network basic service set identifier (BSSID), and so on.

In step S62, the wireless network driver program instructs the packet format conversion module 111c of an infrastructure layer 111b of the network driver interface to execute a conversion process therein.

In step S63, the packet format conversion module 111c converts the received packet 81 to a packet 82, wherein the packet 82 has a header with panel controls, including From Distribution System (From DS) 1 and To Distributed System (To DS) 0, and the transmission columns, which are loaded with a destination address (DA), a wireless local area network basic service set identifier (BSSID), a source address (SA), and so on.

In step S64, the packet format conversion module 111c makes a copy of the network basic service set identifier (BSSID) of the network driver interface to the source address (SA) of the received packet 82, thereby enabling the Windows Vista operating system to determine that the received packet 82 is compatible thereto.

In step S65, the packet format conversion module 111c of the infrastructure layer 111b transmits the packet 82 to the workstation layer (random network layer) 111a via a distribution module 111d for further transmitting to a workstation.

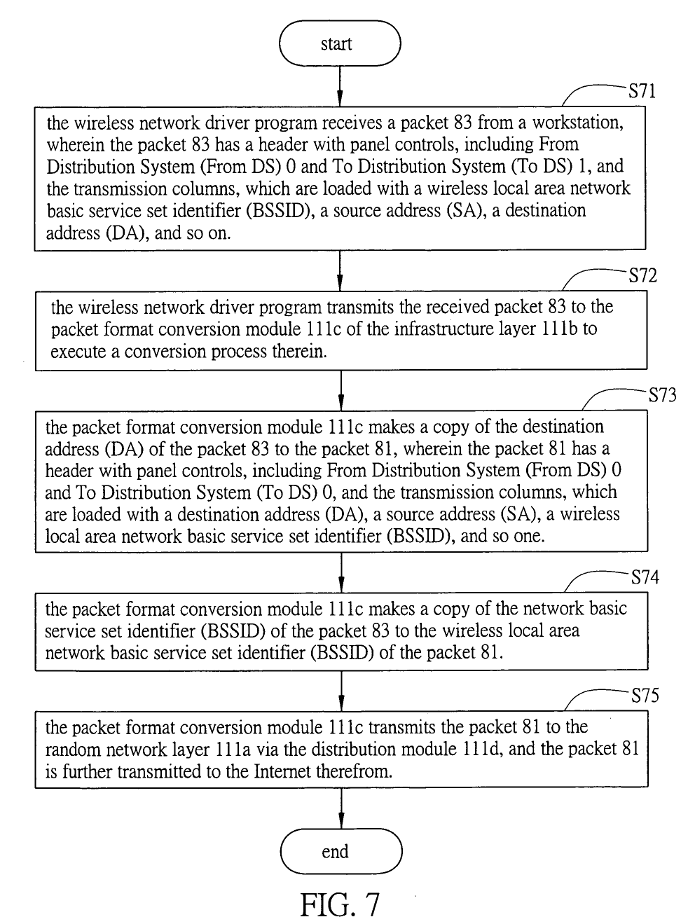

Please refer to FIG. 7, which is a packet receiving flowchart according to the wireless local area network packet transmitting and receiving system of the present invention. As shown in FIG. 7, in step S71, a wireless network driver program receives a packet 83 from a workstation, wherein the packet 83 has a header with panel controls, including From Distribution System (From DS) 0 and To Distribution System (To DS) 1, and the transmission columns, which are loaded with a wireless local area network basic service set identifier (BSSID), a source address (SA), a destination address (DA), and so on.

In step S72, the wireless network driver program transmits the received packet 83 to the packet format conversion module 111c of the infrastructure layer 111b to execute a conversion process therein.

In step S73, the packet format conversion module 111c makes a copy of the destination address (DA) of the packet 83 to the packet 81, wherein the packet 81 has a header with the panel control, including From Distribution System (From DS) 0 and To Distribution System (To DS) 0, and the transmission columns, which are loaded with a destination address (DA), a source address (SA), a wireless local area network basic service set identifier (BSSID), and so on.

In step S74, the packet format conversion module 111c makes a copy of the network basic service set identifier (BSSID) of the packet 83 to the wireless local area network basic service set identifier (BSSID) of the packet 81.

In step S75, the packet format conversion module 111c transmits the packet 81 to the random network layer 111a via the distribution module 111d, and the packet 81 is then further transmitted to the Internet therefrom.

The foregoing descriptions of the detailed embodiments are only illustrated to disclose the features and functions of the present invention and are not restrictive of the scope of the present invention. It should be understood by those in the art that various modifications and variations can be made according to the spirit and principle in the disclosure of the present invention and yet still fall within the scope of the appended claims.

What is claimed is:

1. A wireless local area network packet transmitting and receiving system, comprising:
a network driver interface for receiving commands of activating actions;
a random network layer built inside the network driver interface for receiving and sending wireless packets within a transmission power of the network driver interface;
an infrastructure layer built inside the network driver interface for integrating wireless local area network packets from the random network layer to obtain an integrated packet;
a packet format conversion module disposed between the random network layer and the infrastructure layer for providing wireless local area network bridges receiving and converting the wireless local area network packets of the infrastructure layer, and then transmitting and receiving the wireless local area network packets according to instructions of the network driver interface; and
a distribution module disposed between the random network layer and the infrastructure layer and connected to the infrastructure layer and the random network layer for transmitting the wireless packets.

2. The wireless local area network packet transmitting and receiving system of claim 1, wherein the random network layer is connected with a workstation.

3. The wireless local area network packet transmitting and receiving system of claim 2, wherein after acquiring the integrated packet from the infrastructure layer corresponding to the workstation via the packet format conversion module that is connected with the workstation, the workstation is connected with another workstation via the distribution module corresponding to the workstation.

4. The wireless local area network packet transmitting and receiving system of claim 2, wherein the packet format conversion module is connected to a wireless local area network bridge.

5. The wireless local area network packet transmitting and receiving system of claim 4, wherein the distribution module is connected with the wireless local area network bridge of the packet format conversion module for exchanging wireless packets with the workstation that is connected with the random network layer.

6. The wireless local area network packet transmitting and receiving system of claim 2, wherein the workstation receives a signal from one selected from the group consisting of Internet, email, file transmission and a shared printer.

7. The wireless local area network packet transmitting and receiving system of claim 1, wherein the network driver interface further provides a wireless packet received by the packet format conversion module to a wireless compatibility certification unit, wherein the wireless compatibility certification unit certifies whether the wireless packet is compatible with and supports the wireless packet received by the local area network.

8. The wireless local area network packet transmitting and receiving system of claim 1, wherein the network driver interface is built inside one selected from a group consisting of a personal digital assistant (PDA), a personal computer and a notebook computer.

9. The wireless local area network packet transmitting and receiving system of claim 1, wherein the network driver interface comprises a switch module for enabling the network driver interface to switch to one of a station mode and a software Access Point base station mode.

10. The wireless local area network packet transmitting and receiving system of claim 1, wherein the network driver interface is further connected with a communication protocol.

11. The wireless local area network packet transmitting and receiving system of claim 1, wherein the infrastructure layer further integrates wired local area network packets from the random network layer.
